(19) United States
(12) Patent Application Publication
(10) Pub. No.: US 2013/0135479 A1
(43) Pub. Date: May 30, 2013

(54) Method and Apparatus for Real Time Virtual Tour Automatic Creation

(71) Applicants: Orna Bregman-Amitai, Tel-Aviv (IL); Eduard Oks, Bat-Yam (IL); Noa Garnett, Herzelia (IL)

(72) Inventors: Orna Bregman-Amitai, Tel-Aviv (IL); Eduard Oks, Bat-Yam (IL); Noa Garnett, Herzelia (IL)

(73) Assignee: SAMSUNG ELECTRONICS CO., LTD., Gyeonggi-do (KR)

(21) Appl. No.: 13/305,767

(22) Filed: Nov. 29, 2011

(51) Int. Cl. H04N 7/18

(52) U.S. Cl. 348/158; 348/E07.085

(57) ABSTRACT

A method for generating a virtual tour (VT) comprising while shooting a video of the motion of an image-capturing device, identifying three distinct states, consisting of: a) Turning around (“scanning”); b) Moving forward and backward (“walking”); and c)Staying in place and holding the image-capturing device; and thereafter combining them together to create a virtual tour.

### FIELD OF THE INVENTION

The present invention relates to image processing. More particularly, the invention relates to the creation of movies using mobile apparatus. Still more particularly the invention relates to the automatic creation of a video that comprises a virtual tour.

### BACKGROUND OF THE INVENTION

By Virtual Tour (VT) it is normally intended to refer to a mode that enables a user to look at a certain place and walk around it through non linear data content. The most famous VT product available today on the web is Google's “Street View”, where data is captured by Google a van using dedicated cameras and hardware. There are companies that provide services to create VT content mainly for the real estate agents. However, according to existing solutions the creation of a VT requires dedicated hardware and/or the use of offline editing tools.

The current options for a user to create VT content are:
a) Using a professional company to generate it. Such companies employ dedicated hardware (mainly 360° camera) and dedicated editing tools.
b) Taking images or video and using Photoshop and plug-ins to edit it off-line, which takes a long time and requires careful planning of the capturing process.
c) Google lately bought QuickSee, a company that offers a tool to easily edit video to create VT. Their solution still requires planning of the scene and does not give any feedback while shooting.

According to existing solutions the various editors present much limitation:
All require prior planning of the shooting scene.
All are off-line and therefore no feedback is provided to the user while shooting.
Editing requires time and practice.

It is therefore clear that a solution is needed, that overcomes the drawbacks of the prior art and, inter alia:
provides capturing assistance to the user and feedback while shooting;
Provides automation during editing; and, optionally
Incorporates means for social sharing.

### SUMMARY OF THE INVENTION

The invention is directed to a method for generating a virtual tour (VT) comprising while shooting a video of the motion of an image-capturing device, identifying three distinct states, consisting of:
a. Turning around (“scanning”);
b. Moving forward and backward (“walking”); and
c. Staying in place and holding the image-capturing device; and thereafter combining them together to create a virtual tour.

In one embodiment of the invention the method comprises providing to the user an indication as to the map scene and the current capturing mode.

In an embodiment of the invention the image-capturing device is a smart phone. In another embodiment of the invention the image-capturing device is a tablet PC.

In still another embodiment of the invention a map of the area being captured is created “on the fly”.

In yet a further embodiment of the invention editing tools are provided for editing the map, which may comprise means for associating an image with a location on the map.

### BRIEF DESCRIPTION OF THE DRAWINGS

In the drawings:

FIG. 1 illustrates the creation of a VT, according to one embodiment of the invention. FIGS. 1A-1C comprise photographs (101, 103 and 105) are accompanied by illustrative drawings of the setup (102, 104 and 106, respectively), for further illustration;

FIG. 2 is an accelerometer output, showing data used for the purposes of the invention;

FIG. 3 illustrates transformations taking place in acquired images;

FIG. 4 is a map of an area for which a VT is created according to an example;

FIG. 5 is an example of a GUI according to one embodiment of the invention, which comprises photograph 501, accompanied by illustrative drawing 502 of the setup, for further illustration;

FIG. 6 illustrates a manipulation of the VT created by a user. FIGS. 6A and 6B comprise photographs (601 and 603), accompanied by illustrative drawings (602 and 604, respectively) of the setup, for further illustration;

FIG. 7 illustrates another manipulation of a VT previously created. FIGS. 7A and 7B comprise photographs (701 and 703), accompanied by illustrative drawings (702 and 704, respectively) of the setup, for further illustration; and

FIG. 8 illustrates a further manipulation of a previously created VT. FIGS. 8A and 8B comprise photographs (801 and 803), accompanied by illustrative drawings (802 and 804, respectively) of the setup, for further illustration.

### DETAILED DESCRIPTION OF THE INVENTION

In accordance with the invention suitable software is provided on (or otherwise associated with) a camera device, which guides the user in the process of capturing the VT content, thus enabling the online VT creation.

In one embodiment of the invention, inter alia, the following elements are provided:
a) Capturing—guided capturing that gives the user an indication of the scene captured, and instructs the user regarding the shot being currently taken. The acquisition can be in any suitable video format or raw images.
b) Automatic editing—during the capturing process the system selects the relevant frames for display and builds up the scene map. The automatic editing can be an iterative operation.
c) Review and manually edit: the user may review the result and correct or change it where needed. The user sees the VT on the device and decides if he wants to continue shooting or confirm it.
d) Socially share the VT either with friends on a peer to peer basis or through a server. The sharing of the VT has two modes: (1) View Only, (2) Editable version, which includes metadata.

Acquisition of the VT:

The software associated with the camera device, using image processing technology and/or other sensor's data, analyzes the captured scene while shooting the VT. The capturing process is divided into two main features:
a. Turning around (“scanning”)
b. Moving forward and backward (“walking”)
c. Staying in place and holding the camera.

According to the invention and based on sensors data and image processing, it is possible to recognize the three different situations mentioned above and to combine them together online in order to create a virtual tour. The user has a GUI, which gives him an indication as to the map scene and the current capturing mode.

A map of the captured tour is created while capturing. The map is used for the virtual tour viewer at later stage.

The abovementioned classification is based on a combination of image processing and of sensors data, because:
The sensors (without GPS) cannot detect a difference when the user moves forward or backward as compared to when the user stands still.
Image processing requires non-repetitive patterns to analyze the movement. For example, part of the wall that has no significant pattern may cause an error in detecting turn around activity.

The differentiating between turning around and going forward is based on a combination of parameters from sensors and imaging.

To further illustrate this point, while being outside, where GPS works well, there is a simple way to differentiate—if the camera location changed—the user moved forward and if it did not change—he was either standing or turning around.

The gyro, compass and or accelerometers, on the other hand, cannot tell standing from moving forward. This differentiation must be supported by image processing.

The sensors also suffer from environment noise. For example, the compass is affected by electrical devices found in its vicinities.

The optical flow of consecutive frames can provide the full needed information. For example:
If the pixels are fixed in place—no movement
If the flow is purely horizontal—the user has turned around
If the flow is such that pixels are spread from the center—this means that the user walked forward.

The aforementioned “optical flow” method is one of the suitable methods to determine camera movement between two frames. Other methods known in the art and not discussed herein in detail for the sake of brevity, can also be used.

The capturing of data for the VT may also be non-continuous. For example a user may start at point A, go to point B and then want to capture the VT route from point A to point C. In this case the user may stop capturing at point B, and restart capturing when he is back in point A.

### Map Creation in Real Time of the VT Tour:

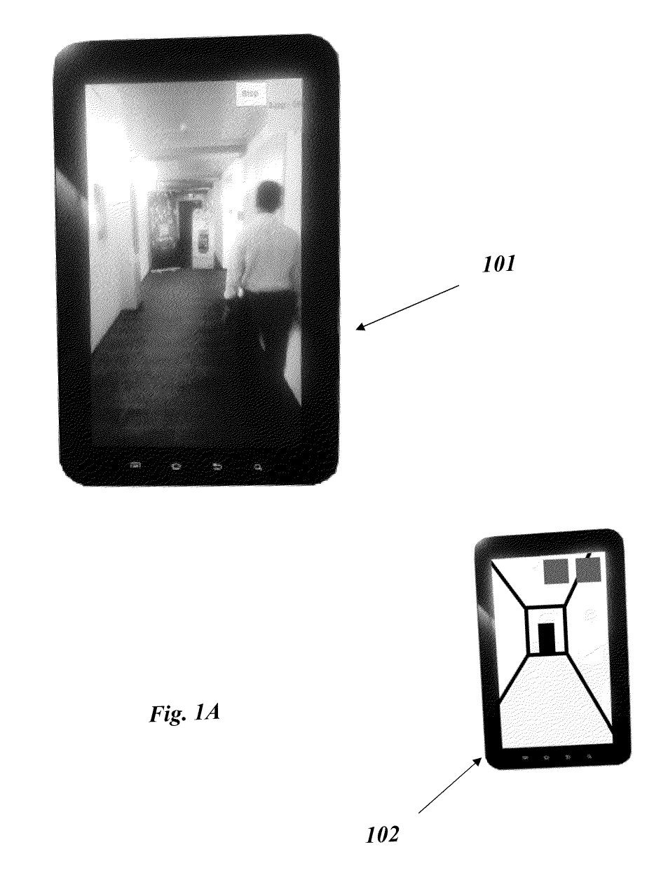

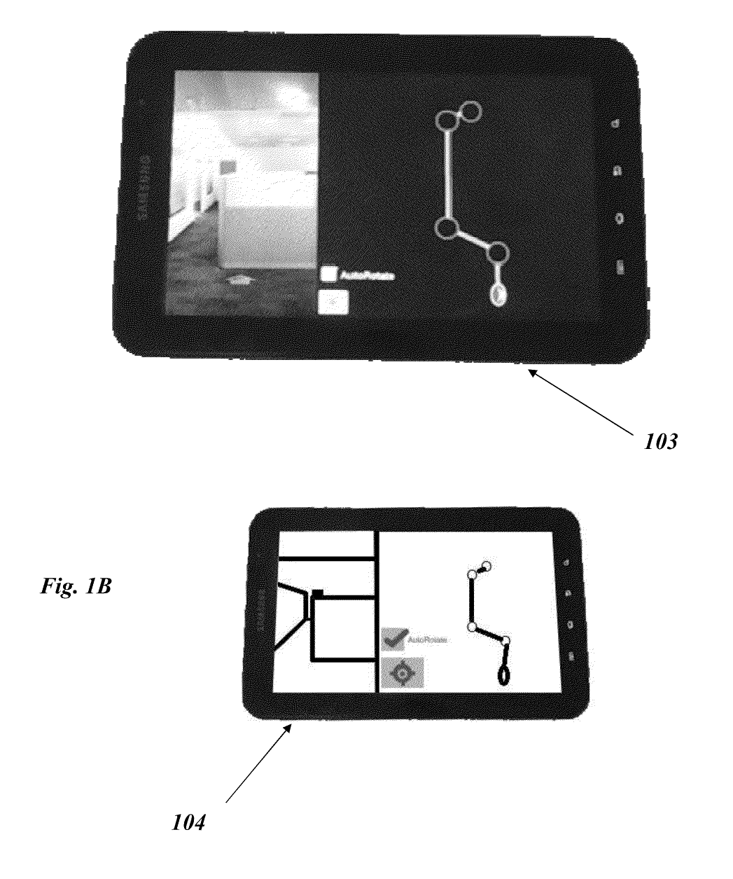

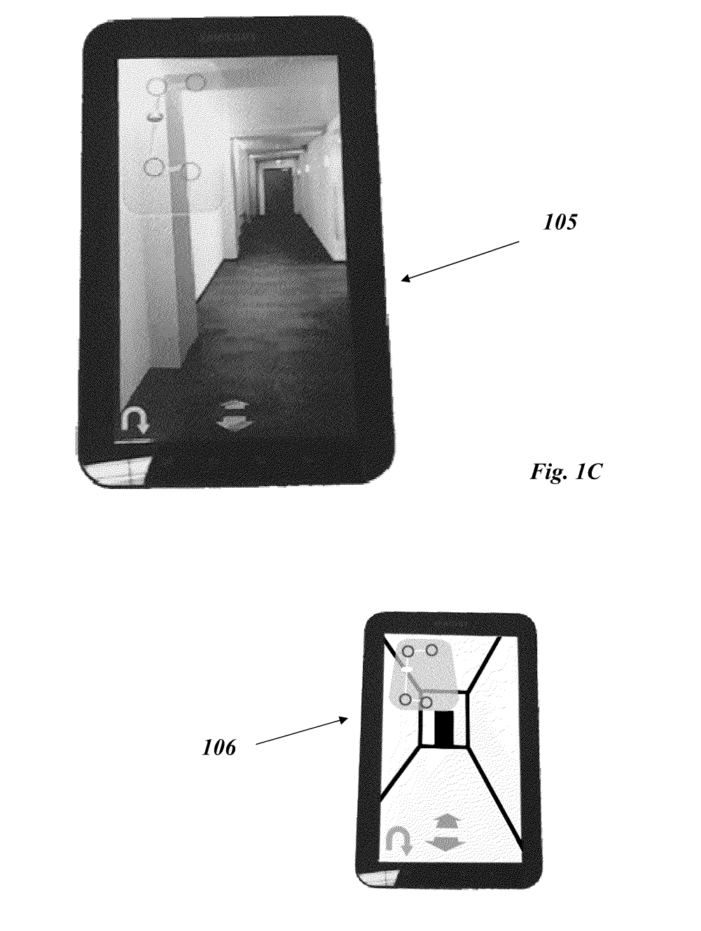

The invention enables the creation and editing to the VT tour map. As shown in the figures and further discussed in detail below, a schematic map is created during the capture process. This map can be presented to the user while capturing the VT online, as shown in the illustrative example of FIG. 1(A-C). A specific, illustrative method to create the map is described below, which enables an average user to create VT content on his mobile device, without the need to use external editing tool, and to see the results during the capturing process.

### Detailed Description of an Illustrative Implementation on a Mobile Phone with Compass and Accelerometers

The following illustrative description makes reference to the technical features and the GUI implemented on an Android mobile phone with compass and accelerometers (but without a gyro). As said, the purpose of the invention is to allow a user to create and share a virtual tour. Once created a virtual tour allows a person to explore a place without actually being there. In one embodiment of the invention an illustrative implementation is divided into 3 stages:
1) Tour capture—the user goes through the tour area and captures a movie of the different places of interest (FIG. 1A). The capture software uses the phone sensors to estimate the user's position and to create a map which is correlated to the view at each point.
2) Tour Map edit—Since the map creation is not optimal (Created with indoor navigation techniques) the user manually fixes the created map at this stage (FIG. 1B), as will be described in greater detail below.
3) Tour view—a viewer provided with the user's device (which is conventional and therefore not described in detail for the sake of brevity) allows the user to walk through the virtual tour. The user can navigate with the map to different places and see what the creator saw while he captured the map (FIG. 1C).

### ILLUSTRATIVE EXAMPLE

The invention was tested using an android galaxy tab (P1 device), as well as on a Galaxy S phone. Android version was Froyo (2.2).

### Capture Engine Description

### Engine I/O

The capture engine receives for each frame the below Inputs:
1. Frame buffer.
2. Sensors data—gravity projection on x, y, z directions, north direction projection on x, y, z directions, compass (actually not used).

It will then output:
1. Current status (scanning, walking etc).
2. Instruction for keeping/ignoring a previous frame.

From VirtualTourApi.h:

unsigned long VirtualTour_HandleData(
VirtualTourInstance inst, unsigned char *frameBuffer, float
accX, float accY, float accZ, float mgtX, float mgtY, float mgtZ,
float cmp,
VT_API_FrameResult* pFrameRes // keep or ignore a previous
frame
);

The process result is a view table where each kept frame is represented as a single row (see detailed description below).

Capture Engine processing description (for an illustrative, specific embodiment)
Analysis Performed for each frame
   1. Perform a 2D rigid registration relative to the previous frame.
   2. Detection stage—Analyze status according to 2D camera position changes and to sensors inputs on last few frames. This step is used to automatically detect scan state (360 deg turn) start and stop and walking state.
   3. Handle the frame according to detected status.
   Below is a detailed description:

Rigid Registration

The motion estimation of the camera is done by SAD (Sum of Absolute Difference) minimization on a set of significant points.

Detection Stage

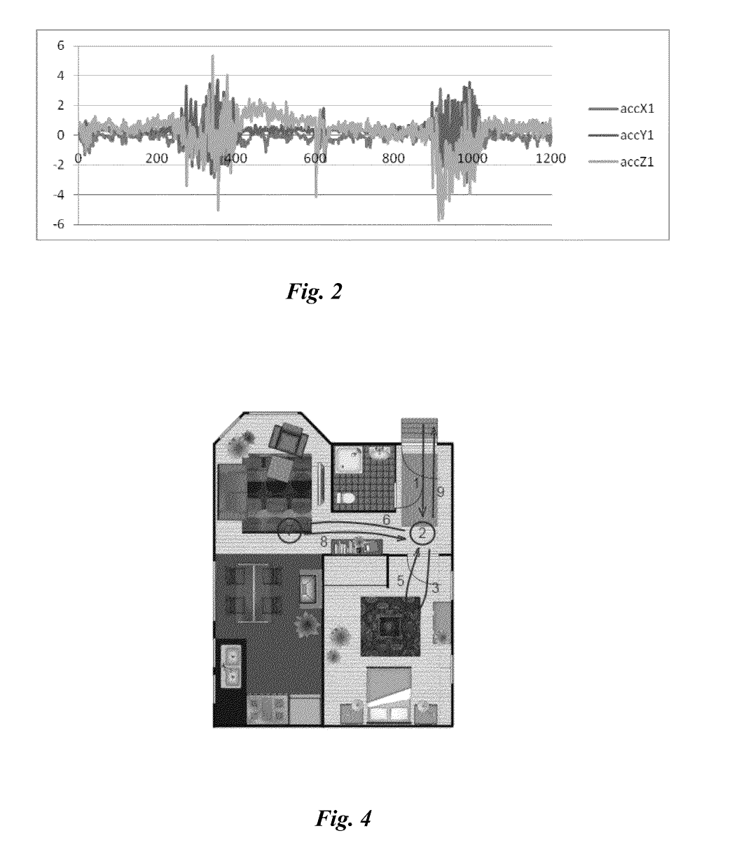

First, the accelerometer inputs' variance is check for the last few frames. Hand shakes while walking are clearly seen on accelerometers input. Scanning happens on frames 65-240, 420-600, 650-890, 1020- (FIG. 2)

If the variance is big and we are currently in “walking” mode—continue walking.

If the variance is small and we are currently in “scanning” mode—continue scanning.

Else—check by 2D registration

If the camera movement by the last few frames' visual information is smooth and horizontal—we are in “scan” mode. Otherwise—in “walk” mode.

If no visual information exists on the last few frames (that is, scanning or walking against a white wall), compass data will replace the visual information in the detection stage.

In general, the visual information is considered more reliable all through the analysis, and azimuth is used only as fallback and for sanity check. This is the result in unreliable inputs used while developing and testing.

Frame Handling

Each scan has a “marker” frame near its start, which is compared and matched to the coming frames when the scan is closed.

When a scan starts, each coming frame is checked. Once a frame with sufficient visual information is detected, it is set to be the marker. Frames of the scan before the marker frame are not kept.

Scan frames are accumulated. Frames are kept so that the gap between them is about ⅙ of the frame size. This means that if the field of view, in the scanning direction, is 45 degrees, a frame will be kept every 7.5 degrees, and a full scan will hold about 48 frames.

After scanning about 270 degrees, we start comparing the current frames to the marker to try “closing” the scan. The 270 threshold represent the unreliability of azimuth estimate based on sensors and image registration inputs.

Once a frame is matched to the marker, the scan is closed. At this stage we need to connect the last frame from walking stage to the relevant scan frame, to create accurate junction point at scan entry.

This is done by comparing the last frame on the path (walking stage) to scan frames.

The user gets a feedback of scan closed, and should continue scanning until he leaves the room.

When the user starts walking out of the room, scan stop is detected, and the first frame of the path is compared to scan frames, to create an accurate junction point at scan exit.

If a scan closing point was missed, a new marker is chosen from among scan frames, the scan beginning is erased, and scanning continues. This is rare, and happens mostly if the scene changed, if the user moved while scanning, or if the device was tilted.

Fallbacks and Detection Errors

Incomplete Scan

If a scan was stopped before being closed, the engine decides whether to keep it as “partial scan” or to convert all the frames to path frames. A scan is kept if it already holds more than 180 degrees.

Very Short Path

If we moved for “scan” to “path” state, and shortly thereafter detected a scan again, we conclude that the scan stop was wrong and probably resulted from a shaking of the user's hand. In this case we continue the previously stopped scan. If we were in “redundant scan” mode, that is, the scan was already closed, we have no problem continuing. If the scan was not yet closed, we must restart the scan (that is—erase the incomplete scan just created), and choose a new marker.

Image Matching

Matching two images is done whenever we need to “connect” two frames that are not consecutive. This can be for scan frame versus either scan marker, scan entry, or scan exit.

Matching is done as following:

First, the two images are registered by 2D translation, as done for consecutive frames. The “significance” of the minima found while registering, that is, the ratio of SAD value on best match to SAD values on other translations, is calculated and kept as a first score to evaluate the match.

Next, homography transformation is found to best transform one image to the other. This homography represents a slight distortion between images, resulting from camera tilt, or from the user moving slightly closer or farther from the scene.

A warped image is created according to 2D translation and homography. The similarity of the warped image to the other one is evaluated by two independent calculations—SAD on a set of selected grid points, uniformly distributed in the image, and cross-correlation on down sampled images.

The three scores—SAD minima significance, SAD on grid points and cross-correlation, are combined and threshold to get a final decision as to the two images match.

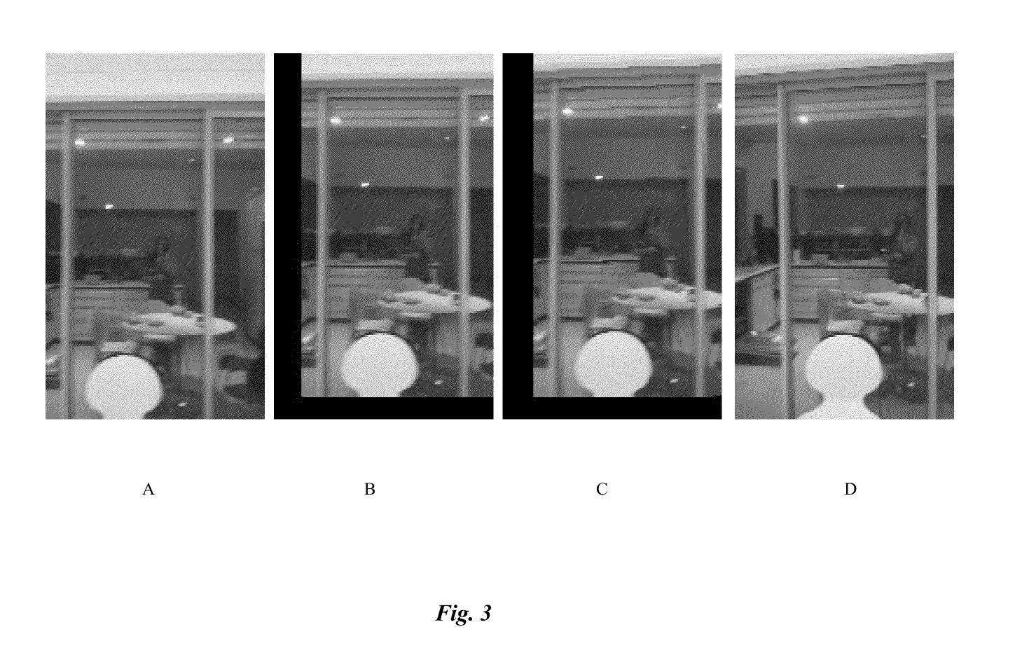

The example shown in FIG. 3 demonstrates how one image is transformed into the other in two stages—the first (FIG. 3B) is a simple 2D translation, and the second (FIG. 3C) is a slight distortion.

View Table Structure
The View table contains a set of metadata parameters for each frame that was chosen to be saved for the virtual tour. Below is a description of the different fields of the table:
   Frame Id: a unique index to the frames number.
   Left Id: an index of the frame to the left of current frame.—1 if there is no such frame exists.
   Right Id: an index of the frame to the right of current frame.—1 if there is no such frame exists.
   Forward Id: an index of the frame ahead of the current frame.—1 if there is no such frame exists.
   Backward Id: an index of the frame behind the current frame.—1 if there is no such frame exists.
   Navigation X: X location of the current frame (This is calculated based on rough indoor navigation algorithm).
   Navigation Y: Y location of the current frame (This is calculated based on rough indoor navigation algorithm).
   Azimuth: heading (relative to north) of the camera for current frame.

This table structure is defined in VirtualTourTypes.H:

```
typedef struct
{
  IM_API_INT mInputId;
  IM_API_INT mLeft, mRight, mForward, mBackward;
  IM_API_FLOAT mNavigationX, mNavigationY;
  IM_API_FLOAT mCmpVal;
  } VT_API_ViewRecord;
```

Creating a Virtual Tour—Application+GUI Description
There are 2 steps to creating a virtual tour. First one is capturing the tour. This process involves going through the tour route and grabbing camera feed of the areas of interest. The second stage involves editing the automatic created map.

Capture Stage

Overview

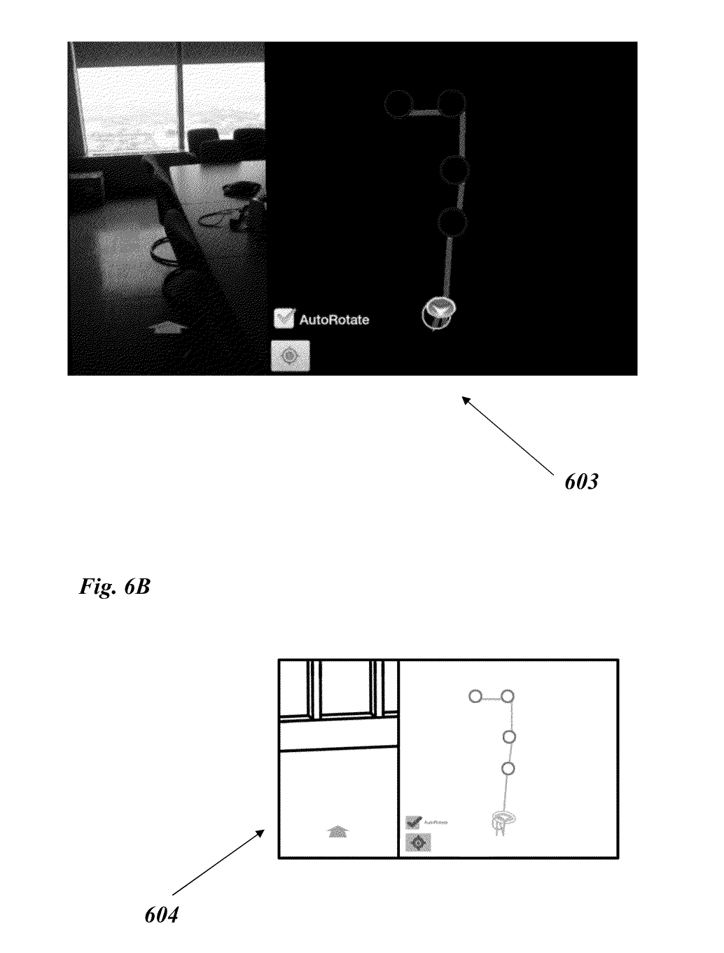

Before starting the capture stage the user should plan a route that will cover all places of interest in the tour (FIG. 6X). The floor plan to the right shows a possible route of capture. Note that there are 2 modes of capture:

1) Room scan—360 deg scan.

2) Corridor scan—scan of a walk from room to room.

In the example of FIG. 4 the user will start walking from the house entrance (marked by route #1) then make a 360 deg turn (marked by circle #2) to scan the house entrance hall and so on until he is done with all areas.

UI

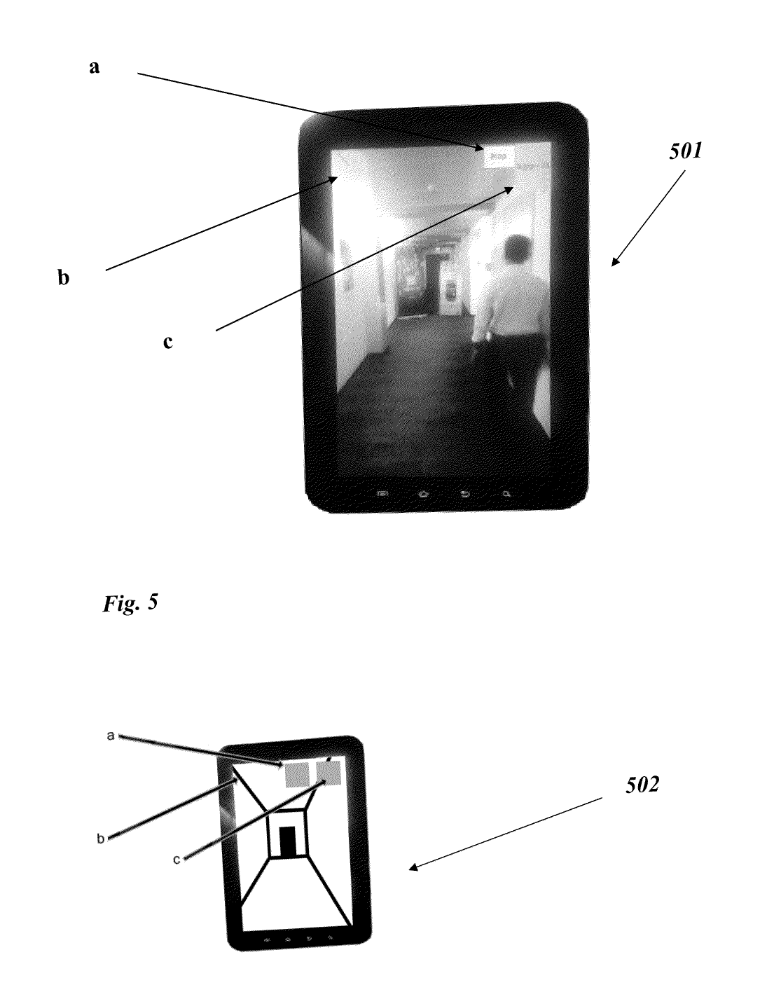

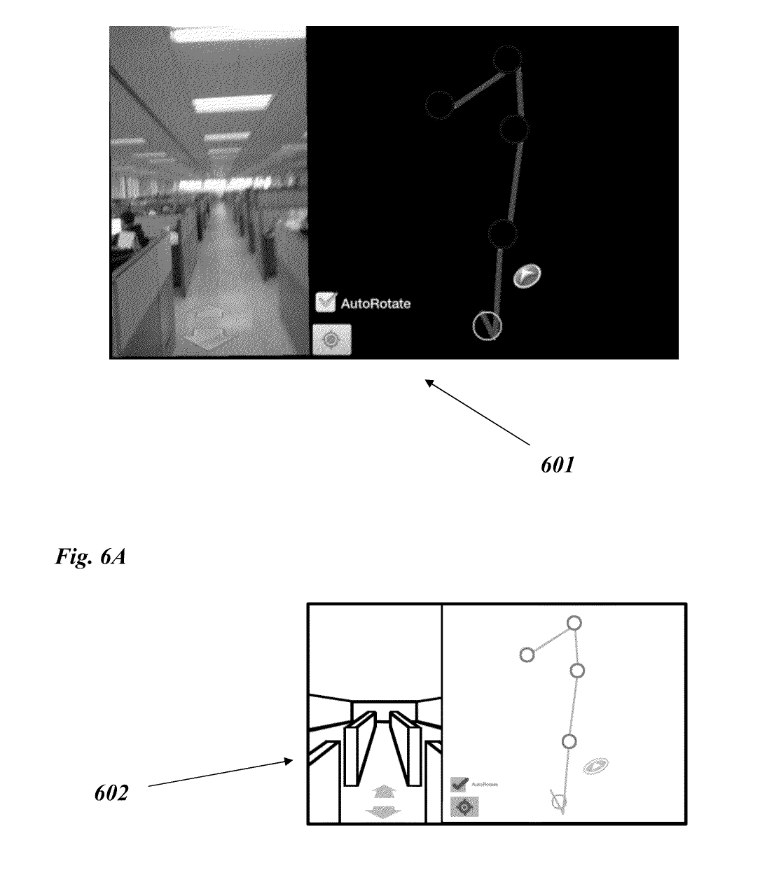

In the capture stage all the user has to do is to press the start button (“a” in FIG. 5) to start recording and stop button to stop recording.

Other than the start/stop button the screen has 2 more GUI indications:
The compass (“b” in FIG. 5) shows the current azimuth of the user.
A state indicator (“c” in FIG. 5)—this indicator informs the user about the automatic capturing state. There are 4 states which are represented by the indicator color:
   Green—Corridor mapping is currently active.
   Blue—Room mapping (360 deg turn) is currently active.
   Grey—Current Room mapping is complete. This is to tell the user that the application detected a full scan of a room and he can continue walking to next corridor.
   Red—Virtual tour engine error.

In addition, in this specific illustrative example, the user can use the android menu button in order to perform the following operations:
View Recording—will launch the vtour viewer for the currently finished vtour file. If this is selected before recording the user will be asked to choose file from a list.
View Map—will launch the vtour map viewer for the currently finished vtour file. If this is selected before recording the user will be asked to choose file from list.
List—Will let the user to choose an existing vtour file from a list and open it in the map viewer.
Delete—Will let the user choose an existing vtour file from a list and delete it.
Delete last recording—will delete the last vtour file recorded.

Map Edit Stage

After finishing the capture stage, a database containing all the images and their calculated location is available. From that database the application automatically creates a map. Since the sensors data is not accurate enough a manual map editing is needed. This is done by the map edit stage. The map edit stage allows the user the following changes to the map:

Room Movement

Long press on a room and then drag it to the desired new position. By doing so the user can fix the room locations to match their actual location. The example of FIG. 6 shows a before fix (FIG. 6A) and after fix (FIG. 6B) screen shots. The user moved the rooms to match the actual 90 degree turns he made and straight line walk.

In order to move a room the user needs to long press on a room and drag it to the new desired position. Note that at the end of all changes the user needs to save the new vtour file (via options menu→save).

Room Merge

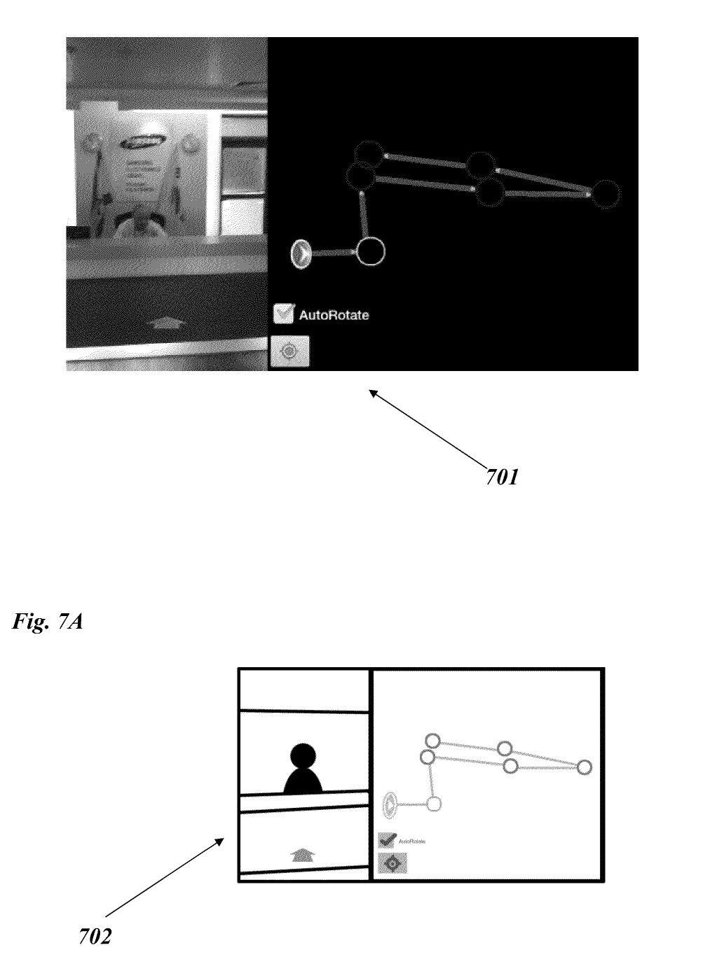

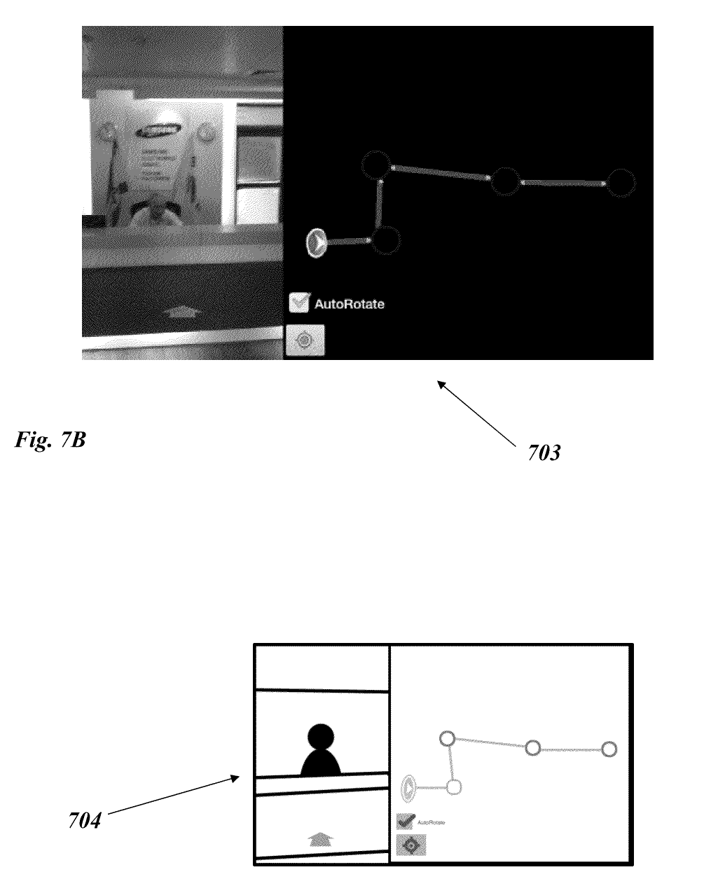

If the same room is scanned twice it is possible to merge two rooms. For example in the floor plan showed in FIG. 7, room#2 is scanned first when coming from corridor #1 and second time when coming from corridor #5. In that case the two rooms will have to be merged. The screen shots of FIG. 7 show a before (FIG. 7A) and after (FIG. 7B) merge of a typical map.

In order to actually make a room merge the user long presses on a room and then drags it over the target room for merge. The user will be asked if he wants to merge the rooms and once he presses ok the merge will be done. Note that at the end of all changes the user needs to save the new vtour file (via options menu→save).

Corridor Split

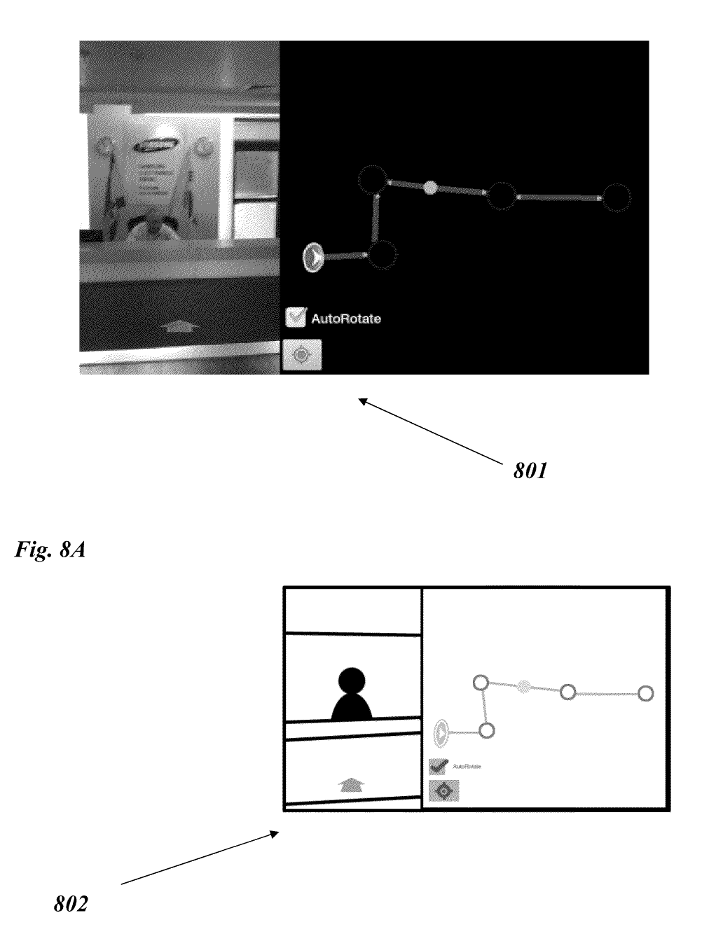

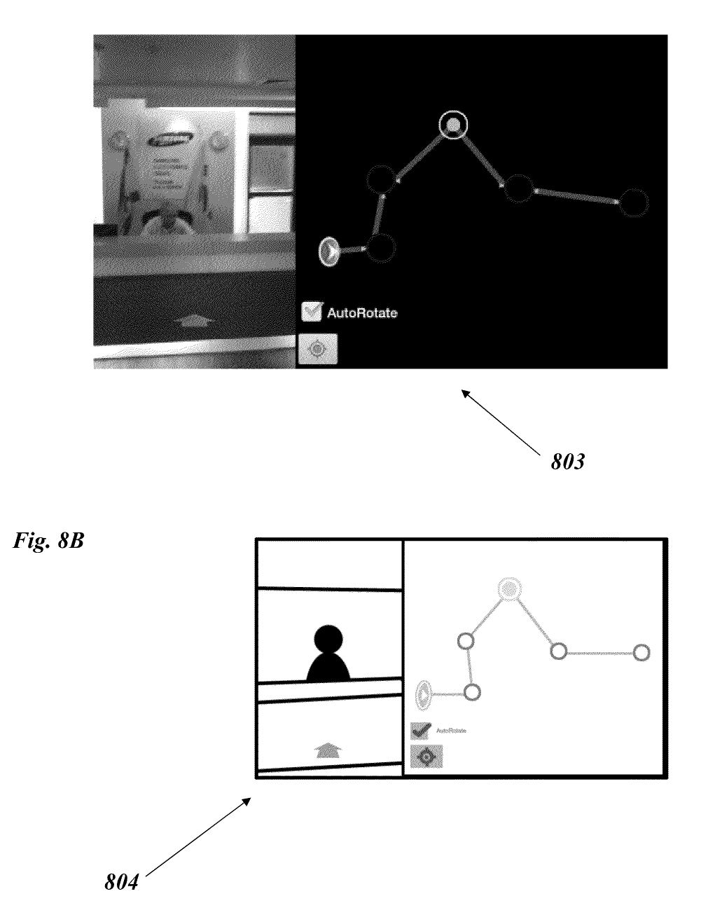

The map view, always show a corridor as a straight line between 2 rooms. Some times when a corridor is not straight it is desired to add a split point in a corridor line. That new split point can be moved and create a corridor which is not straight. FIG. 8 is a screen capture illustrating the adding (FIG. 8A) and moving (FIG. 8B) of a split point.

In order to create a corridor split point the user needs to long press on the corridor at the location of the desired split point. In order to move a split point the user long presses the point and then moves it. Note that at the end of all changes the user needs to save the new vtour file (via options menu→save).

Corridor Split Merge

It is possible to merge a corridor split point with a room. This is needed in cases a user maps several rooms while walking in one direction and then returns back just in order to record the corridors view on the other direction.

Note that at the end of all changes the user needs to save the new vtour file (via options menu→save).

Options Menu

Pressing the android options menu allows the user to do the following operations:
Open—choose a vtour file to edit.
View—runs the vtour viewer.
Settings—Opens the setting screen which allows:
   Check “auto rotate” to allow map to rotate according to the current azimuth.
   Check “Show Map Debug Info” to show position of each frame on the map (marked with an arrow in the direction of picture taken).
Save—save all the changes made in the map.

All the above description and examples have been provided for the purpose of illustration and are not meant to limit the invention in any way. Many alternative sensors and sensor analyses can be provided, as well as many other viewing and editing options, all without exceeding the scope of the invention.

1. A method for generating a virtual tour (VT) comprising while shooting a video of the motion of an image-capturing device, identifying three distinct states, consisting of:
a. Turning around (“scanning”);
b. Moving forward and backward (“walking”); and
c. Staying in place and holding the image-capturing device;
and thereafter combining them together to create a virtual tour.

2. A method according to claim 1, comprising providing to the user an indication as to the map scene and the current capturing mode.

3. A method according to claim 1, wherein the image-capturing device is a smart phone.

4. A method according to claim 1, wherein the image-capturing device is a tablet PC.

5. A method according to claim 1, wherein a map of the area being captured is created “on the fly”.

6. A method according to claim 5, further comprising providing editing tools for editing the map.

7. A method according to claim 6, wherein the editing tools comprise means for associating an image with a location on the map.
